(19) United States
(12) Patent Application Publication
(10) Pub. No.: US 2014/0349176 A1
(43) Pub. Date: Nov. 27, 2014

(54) ADDITIVE FOR ELECTROLYTE, ELECTROLYTE AND RECHARGEABLE LITHIUM BATTERY

(71) Applicant: Samsung SDI Co., Ltd., Yongin-si (KR)

(72) Inventors: Vladimir Egorov, Yongin-si (KR); Jiten Singh, Yongin-si (KR); Woo-Cheol Shin, Yongin-si (KR); Maeng-Eun Lee, Yongin-si (KR); Jung-Yi Yu, Yongin-si (KR); Sang-Il Han, Yongin-si (KR); Sang-Hoon Kim, Yongin-si (KR); Duck-Hyun Kim, Yongin-si (KR); Myung-Hwan Jeong, Yongin-si (KR); Seung-Tae Lee, Yongin-si (KR); Tae-Hyun Bae, Yongin-si (KR); Mi-Hyun Lee, Yongin-si (KR); Eon-Mi Lee, Yongin-si (KR); Ha-Rim Lee, Yongin-si (KR); Moon-Sung Kim, Yongin-si (KR); In-Haeng Cho, Yongin-si (KR); E-Rang Cho, Yongin-si (KR); Dong-Myung Choi, Yongin-si (KR); Makhmut Khasanov, Yongin-si (KR); Pavel Alexandrovich Shatunov, Yongin-si (KR); Alexey Tereshchenko, Yongin-si (KR); Denis Chernyshov, Yongin-si (KR)

(73) Assignee: Samsung SDI Co., Ltd., Yongin-si (KR)

(21) Appl. No.: 14/259,022

(22) Filed: Apr. 22, 2014

(30) Foreign Application Priority Data
May 21, 2013 (KR) 10-2013-0057242

(51) Int. Cl. H01M 10/0567; H01M 10/0525

(52) U.S. Cl. CPC H01M 10/0567; H01M 10/0525
USPC 429/188; 549/62; 549/71

(57) ABSTRACT

In an aspect, a rechargeable lithium battery that includes a positive electrode; negative electrode; a separator interposed between the positive electrode and the negative electrode; and an electrolyte including a lithium salt, a non-aqueous organic solvent, and an additive is provided. The additive may be an optionally substituted thiophene.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0057242 filed in the Korean Intellectual Property Office on May 21, 2013, the disclosure of which is incorporated herein by reference in its entirety.

### BACKGROUND

1. Field

This disclosure relates to an additive for an electrolyte, an electrolyte and a rechargeable lithium battery including the same.

2. Description of the Related Technology

Batteries transform chemical energy generated from an electrochemical redox reaction of a chemical material in the battery into electrical energy. Such batteries are divided into a primary battery, which should be disposed of after the energy of the battery is all consumed, and a rechargeable battery, which can be recharged many times. The rechargeable battery may be charged/discharged many times based on the reversible transformation between chemical energy and electrical energy.

Recent developments in high-tech electronics have allowed electronic devices to become small and light in weight leading to an increase in production of portable electronic devices. A power source for such portable electronic devices must have high capacity and energy density, light weight and a long calendar life. To date, rechargeable lithium batteries represent one of the most viable alternatives on the market. This fact stimulates an increasing interest in research and development of this type of power sources worldwide.

Typically, rechargeable lithium batteries are fabricated by injecting electrolyte into an electrode assembly, which includes a positive electrode comprising a positive active material capable of deintercalating/intercalating lithium ions, and a negative electrode comprising a negative active material capable of intercalating/deintercalating lithium ions during charge/discharge of the battery, respectively.

An electrolyte includes a lithium salt dissolved in an organic solvent, and may determine stability and performance of a rechargeable lithium battery.

### SUMMARY

Some embodiments provide an additive for an electrolyte that improves performance while ensuring stability.

Some embodiments provide an electrolyte for a rechargeable lithium battery including the additive for an electrolyte.

Some embodiments provide a rechargeable lithium battery including the electrolyte.

Some embodiments provide an additive for an electrolyte represented by the following Chemical Formula 1.

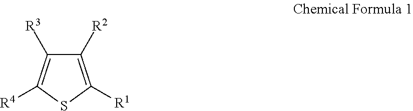

wherein, in Chemical Formula 1,

R¹ and R⁴ are each independently hydrogen or a C1 to C12 alkyl group; R² and R³ are each independently —OR″ (wherein R′ is a C1 to C12 alkyl group) or —R″C(O)—OR′″ (wherein R″ is a C1 to C4 alkylene (alkanediyl) group, and R′″ is a C1 to C12 alkyl group. At least one of the moieties R¹ to R⁴ is different from both hydrogen and alkyl groups.

In some embodiments, the above Chemical Formula 1 may be represented by the following Chemical Formula 2 or Chemical Formula 3.

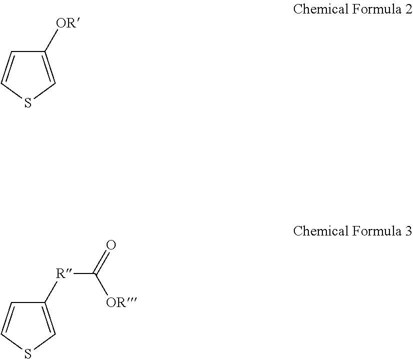

In some embodiments of the above Chemical Formulae 2 and 3,

R′ and R′″ are independently a C1 to C12 alkyl group, and R″ is a C1 to C4 alkylene (alkanediyl) group.

In some embodiments, the above Chemical Formula 1 may be represented by the following Chemical Formula 4 or Chemical Formula 5.

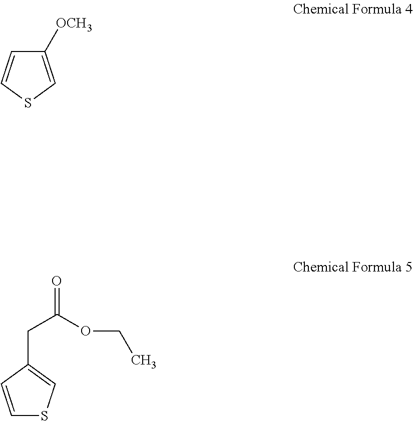

Some embodiments provide an electrolyte for a rechargeable lithium battery, which includes a lithium salt, a non-aqueous organic solvent, and the additive represented by the above Chemical Formula 1.

In some embodiments, the additive for an electrolyte may be represented by one selected from the above Chemical Formula 2 to Chemical Formula 5.

In some embodiments, the additive for an electrolyte may be included in amount of about 0.001 wt % to about 5 wt % based on the total amount of the electrolyte.

In some embodiments, the additive for an electrolyte may be included in an amount of about 0.01 wt % to about 2 wt % based on the total amount of the electrolyte.

Some embodiments provide a rechargeable lithium battery, which includes a positive electrode including a positive active material, a negative electrode including a negative active material, and the electrolyte.

In some embodiments, the rechargeable lithium battery may further include a passivation film positioned on the surface of the positive electrode surface.

In some embodiments, the passivation film is stably formed on the surface of a positive electrode by an additive in electrolyte and thus, may improve performance of a battery and simultaneously increase flame retardant of an electrolyte and thus, secure stability and safety.

### BRIEF DESCRIPTION OF THE DRAWINGS

FIG. 1 is a schematic view showing a rechargeable lithium battery according to one embodiment,

FIG. 2 is a graph showing decomposition voltages of electrolytes in the half-cells according to Examples 3 and 4 and Comparative Examples 1 and 2,

FIG. 3 is a graph showing capacity retentions of the coin cells according to Example 6 and Comparative Example 4 depending on a cycle,

FIG. 4 is a graph showing capacity retentions of the coin cells according to Example 8 and Comparative Example 4 depending on a cycle,

FIG. 5 is a graph showing capacity retentions of the coin cells according to Examples 7 and 9 and Comparative Examples 3 and 4 depending on a cycle, and

FIG. 6 is a LSV graph showing a current change depending on change of a voltage applied to the coin cells according to Example 9 and Comparative Example 5.

### DETAILED DESCRIPTION

Hereinafter, exemplary embodiments will be described in detail. However, this disclosure may be embodied in many different forms and is not construed as limited to the exemplary embodiments set forth herein.

As used herein, when a definition is not otherwise provided, the term ‘substituted’ may refer to one substituted with a halogen (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C20 alkoxy group, a C1 to C20 heteroalkyl group, a C3 to C20 heteroarylalkyl group, a C3 to C30 cycloalkyl group, a C3 to C15 cycloalkenyl group, C6 to C15 cycloalkynyl group, a C2 to C20 heterocycloalkyl group, and a combination thereof, instead of hydrogen of a compound.

As used herein, when a definition is not otherwise provided, the term ‘hetero’ may refer to one including 1 to 3 hetero atoms selected from N (nitrogen), O (oxygen), S (sulfur), and P (phosphorus).

As used herein, “Cₐ to C_{b}” or “C_{a-b}” in which “a” and “b” are integers refer to the number of carbon atoms in the specified group. That is, the group can contain from “a” to “b”, inclusive, carbon atoms. Thus, for example, a “C1 to C4 alkyl” or “C₁₋₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—.

As used herein, the term “alkyl” refers to a branched or unbranched aliphatic hydrocarbon group. In some embodiments, alkyls may be substituted or unsubstituted. Alkyls include, but are not limited to, methyl, ethyl, propyl, isopropyl, butyl, isobutyl, tertiary butyl, pentyl, hexyl, and the like, each of which may be optionally substituted. In some embodiments, the alkyl may have from 1 to 20 carbon atoms. In another embodiment, the alkyl may have from 1 to 6 carbon atoms. For example, C₁₋₆alkyl includes, but is not limited to, methyl, ethyl, propyl, isopropyl, butyl, iso-butyl, sec-butyl, pentyl, 3-pentyl, hexyl, and the like.

As used herein, the term “fluoroalkyl” refers to an alkyl substituted with at least one fluoro group.

As used herein, the term “oxaalkyl” refers to an alkyl, in which one or more non-consecutive carbon atoms are replaced by oxygen atoms. Examples of oxaalkyls include, but are not limited to, methoxy, ethoxy, n-propoxy, iso-propoxy, methoxymethyl (CH₃O—CH₂—), 1-methoxyethyl (CH₃—CH(OCH₃)—), 2-methoxyethyl (CH₃O—CH₂—CH₂—), ethoxymethyl, and the like.

As used herein, the term “alkoxy” refers to the formula —OR wherein R is an alkyl as is defined above, such as “C₁₋₂₀ alkoxy”, including but not limited to methoxy, ethoxy, n-propoxy, 1-methylethoxy (isopropoxy), n-butoxy, iso-butoxy, sec-butoxy, and tert-butoxy, and the like.

As used herein, the term “cycloalkyl” refers to a fully saturated carbocyclyl ring or ring system. Examples include cyclopropyl, cyclobutyl, cyclopentyl, and cyclohexyl.

As used herein, the term “alkenyl” refers to an acyclic hydrocarbon group of from two to twenty carbon atoms containing at least one carbon-carbon double bond including, but not limited to, ethenyl (vinyl), 1-propenyl, 2-propenyl, 2-methyl-1-propenyl, 1-butenyl, 2-butenyl, and the like. In some embodiments, alkenyls may be substituted or unsubstituted. In some embodiments, the alkenyl may from 2 to 40 carbon atoms.

As used herein, the term “alkynyl” refers to a hydrocarbon group of from two to twenty carbon atoms containing at least one carbon-carbon triple bond including, but not limited to, ethynyl, 1-propynyl, 1-butynyl, 2-butynyl, and the like. In some embodiments, alkynyls may be substituted or unsubstituted. In some embodiments, the alkynyl may have from 2 to 4 carbon atoms.

As used herein, the term “aromatic” refers to a ring or ring system having a conjugated pi electron system and includes both carbocyclic aromatic (e.g., phenyl) and heterocyclic aromatic groups (e.g., pyridine). The term includes monocyclic or fused-ring polycyclic (i.e., rings which share adjacent pairs of atoms) groups provided that the entire ring system is aromatic.

As used herein, the term “aryl” refers to an aromatic ring or ring system (i.e., two or more fused rings that share two adjacent carbon atoms) containing only carbon in the ring backbone. When the aryl is a ring system, every ring in the system is aromatic. Examples of aryl groups include, but are not limited to, phenyl, biphenyl, naphthyl, phenanthrenyl, naphthacenyl, and the like. In some embodiments, aryls may be substituted or unsubstituted.

As used herein, the term “haloaryl” refers to an aryl group substituted with at least one halo group.

As used herein, the term “heteroaryl” refers to an aromatic ring system radical in which one or more ring atoms are not carbon, namely heteroatom, having one ring or multiple fused rings. In fused ring systems, the one or more heteroatoms may be present in only one of the rings. Examples of heteroatoms include, but are not limited to, oxygen, sulfur and nitrogen. Examples of heteroaryl groups include, but are not limited to, furanyl, thienyl, imidazolyl, quinazolinyl, quinolinyl, isoquinolinyl, quinoxalinyl, pyridinyl, pyrrolyl, oxazolyl, indolyl, and the like.

As used herein, “cycloalkenyl” refers to a cyclic hydrocarbon group of from three to fifteen carbon atoms containing at least one double bond, wherein no ring in the ring system is aromatic including, but not limited to, cyclopropenyl, cyclopentenyl, cyclohexenyl, cycloheptenyl and the like.

As used herein, the term “cycloalkynyl” refers to a cyclic hydrocarbon group of from six to fifteen carbon atoms containing at least one carbon-carbon triple bond.

As used herein, “heterocycloalkyl” refers to a non-aromatic cyclic ring or ring system containing at least one heteroatom in the ring backbone.

As used herein, “heteroalkyl” means an alkyl group containing at least one heteroatom.

As used herein, the term “arylalkyl” refers to an aryl group connected, as a substituent, via an alkylene group, such as “C₇₋₃₀ arylalkyl” or “C₇₋₁₄ arylalkyl” and the like, including but not limited to benzyl, 2-phenylethyl, 3-phenylpropyl, and naphthylethyl. In some cases, the alkylene group is a lower alkylene group (i.e., a C₁₋₄ alkylene group).

As used herein, the term “aryloxy” refers to an aryl group connected, as a substituent, via an —O— group, such as phenoxy and the like.

As used herein, the term “heteroarylalkyl” refers to an heteroaryl group connected, as a substituent, via an alkylene group.

Hereinafter, an additive for an electrolyte according to one embodiment is described.

In some embodiments, the additive for an electrolyte may be a compound represented by the following Chemical Formula 1.

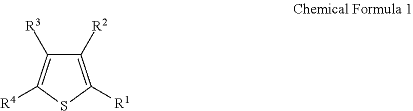

wherein, in Chemical Formula 1,

R¹, R², R³ and R⁴ are each independently selected from hydrogen, a C1 to C12 alkyl group, a C1 to C12 alkenyl group, a C1 to C12 alkoxy group, a C1 to C12 oxaalkyl group, a C6 to C20 aryloxy group, a halogen, a C1 to C12 fluoroalkyl group, nitro group, a C6 to C20 aryl group, a C2 to C20 heteroaryl group, a C6 to C20 haloaryl group, —NR⁵R⁶ (wherein R⁵ and R⁶ are each independently selected from hydrogen, an alkyl group, an alkenyl group, an aryl group, and an oxaalkyl group, or R⁵ and R⁶ may form a ring), R⁷—C(O)—, R⁷—O—C(O)—, R⁷—C(O)—O—, R⁷—O—C(O)—CH₂— (wherein R⁷ is at least one selected from an alkyl group, an aryl group, a fluoroalkyl group, a haloaryl group, and a heteroaryl group) aliphatic quaternary ammonium ion and CₙH₂ₙ₊₁₋ₘ(CN)ₘ (wherein n is an integer of 1 to 12, and m is an integer of 1 to 6), —OR′ (wherein R′ is a C1 to C12 alkyl group) and —R″C(O)—OR′″ (wherein R″ is a C1 to C4 alkylene (alkanediyl) group, and R′″ is a C1 to C12 alkyl group)₊. At least one of the moieties R¹ to R⁴ is different from both hydrogen and alkyl groups.

In some embodiments, R¹ and R⁴ may be each independently hydrogen or a C1 to C12 alkyl group, and R² and R³ may be each independently —OR′ (wherein R′ is a C1 to C12 alkyl group) or —R″C(O)—OR′″ (wherein R″ is a C1 to C4 alkylene (alkanediyl) group, and R′″ is a C1 to C12 alkyl group).

In some embodiments, the additive for an electrolyte may be a compound represented by the following Chemical Formula 2 or Chemical Formula 3.

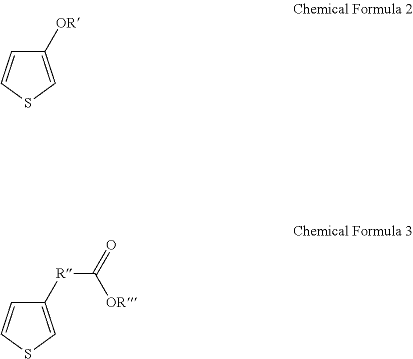

wherein, in Chemical Formulae 2 and 3,

R′ and R′″ are independently a C1 to C12 alkyl group, and R″ is a C1 to C4 alkylene (alkanediyl) group.

In some embodiments, the additive for an electrolyte may be a compound represented by the following Chemical Formula 4 or Chemical Formula 5.

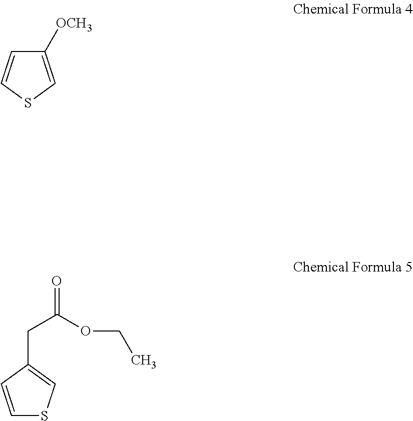

In some embodiments, the additive for an electrolyte may be used by adding in an electrolyte for a rechargeable lithium battery. In some embodiments, the additive for an electrolyte may cause a decomposition reaction on the surface of a positive electrode and thus, form a stable passivation film, improving cycle life characteristics of a battery.

Hereinafter, an electrolyte for a rechargeable lithium battery according to one embodiment is described.

An electrolyte for a rechargeable lithium battery according to one embodiment includes a lithium salt, a non-aqueous organic solvent, and an additive.

In some embodiments, the lithium salt is dissolved in an organic solvent, supplies lithium ions in a battery, and improves lithium ion transportation between positive and negative electrodes therein. Examples of the lithium salt may be one or more selected from LiPF₆, LiBF₄, LiSbF₆, LiAsF₆, LiN(SO₂C₂F₅)₂, Li(CF₃SO₂)₂N, LiN(SO₃C₂F₅)₂, LiCF₃SO₃, LiC₄F₉SO₃, LiClO₄, LiB(CN)₄, LiC(CF₃SO₂)₃, LiN(CₓF₂ₓ₊₁SO₂)(C_{y}F_{2y+1}SO₂) (wherein, x and y are natural numbers of 1 to 20, respectively), LiCl, and LiI.

In some embodiments, the lithium salt may be used in a concentration ranging from about 0.1 M to about 2.0 M. When the lithium salt is included at the above concentration range, an electrolyte may have excellent performance and lithium ion mobility due to optimal electrolyte conductivity and viscosity.

The non-aqueous organic solvent serves as a medium for transmitting ions taking part in the electrochemical reaction of a battery.

In some embodiments, the non-aqueous organic solvent may be a carbonate-based, ester-based, ether-based, ketone-based, alcohol-based, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), fluoroethylene carbonate (FEC), propylene carbonate (PC), butylene carbonate (BC), and the like, and the ester-based solvent may include methyl acetate, ethyl acetate, n-propyl acetate, dimethylacetate, methylpropionate, ethylpropionate, ethylbutyrate, gamma-butyrolactone, decanolide, γ-valerolactone, mevalonolactone, caprolactone, and the like.

In some embodiments, the ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. The alcohol-based solvent may include ethanol, isopropyl alcohol, and the like, and the aprotic solvent may include nitriles such as R—CN (wherein R is a hydrocarbon group having a C2 to C20 linear, branched, or cyclic structure, and may include a double bond, an aromatic ring, or an ether bond) and the like; amides such as dimethylformamide or dimethylacetamide, and the like, dioxolanes such as 1,3-dioxolane, and the like, sulfolanes, and the like.

In some embodiments, the non-aqueous organic solvent may be used singularly or in a mixture. When the organic solvent is used in a mixture, the mixture ratio may be controlled in accordance with a desirable battery performance.

In some embodiments, the carbonate-based solvent is prepared by mixing a cyclic carbonate and a linear carbonate. The cyclic carbonate and the linear carbonate are mixed together in the volume ratio of about 1:1 to about 1:9. Within this range, performance of electrolyte may be improved.

In some embodiments, the non-aqueous organic solvent of the present invention may further include an aromatic hydrocarbon-based organic solvent as well as the carbonate-based solvent. Herein, the carbonate-based solvent and aromatic hydrocarbon-based organic solvent may be mixed at a volume ratio of about 1:1 to about 30:1.

In some embodiments, the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, biphenyl, cyclohexylbenzene, and a combination thereof.

In some embodiments, the additive may be represented by the following Chemical Formula 1.

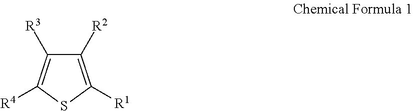

wherein, in Chemical Formula 1,

R¹, R², R³ and R⁴ are each independently selected from hydrogen, a C1 to C12 alkyl group, a C1 to C12 alkenyl group, a C1 to C12 alkoxy group, a C1 to C12 oxaalkyl group, a C6 to C20 aryloxy group, a halogen, a C1 to C12 fluoroalkyl group, nitro group, a C6 to C20 aryl group, a C2 to C20 heteroaryl group, a C6 to C20 haloaryl group, —NR⁵R⁶ (wherein R⁵ and R⁶ are each independently selected from hydrogen, an alkyl group, an alkenyl group, an aryl group, and an oxaalkyl group, or R⁵ and R⁶ may form a ring), R⁷—C(O)—, R⁷—O—C(O)—, R⁷—C(O)—O—, R⁷—O—C(O)—CH₂— (wherein R⁷ is at least one selected from an alkyl group, an aryl group, a fluoroalkyl group, a haloaryl group, and a heteroaryl group) aliphatic quaternary ammonium ion and CₙH₂ₙ₊₁₋ₘ(CN)ₘ (wherein n is an integer of 1 to 12, and m is an integer of 1 to 6), —OR′ (wherein R′ is a C1 to C12 alkyl group), and —R″C(O)—OR′″ (wherein R″ is a C1 to C4 alkylene (alkanediyl) group, and R′″ is a C1 to C12 alkyl group)₊. At least one of the moieties R¹ to R⁴ is different from both hydrogen and alkyl groups.

In some embodiments, R¹ and R⁴ may be each independently hydrogen or a C1 to C12 alkyl group, and the R² and R³ may be each independently —OR′ (wherein R′ is a C1 to C12 alkyl group) or —R″C(O)—OR′″ (wherein R″ is a C1 to C4 alkylene (alkanediyl) group, and R′″ is a C1 to C12 alkyl group).

In some embodiments, the first additive may be a compound represented by one selected from the following Chemical Formula 2 to Chemical Formula 5.

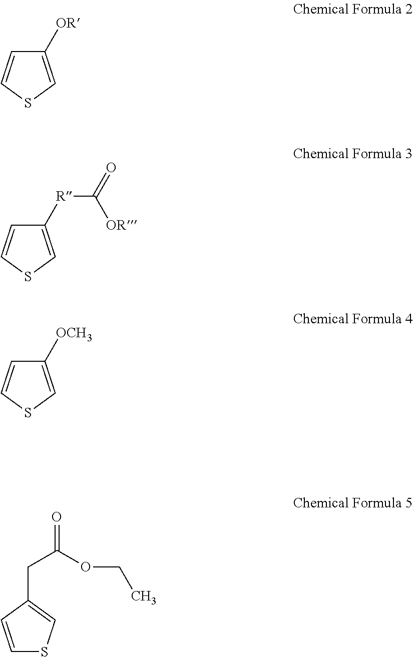

wherein, in Chemical Formulae 2 and 3,

R′ and R′″ are independently a C1 to C12 alkyl group, and R″ is a C1 to C4 alkylene (alkanediyl) group.

In some embodiments, the additive for an electrolyte may not only improve flame retardant of an electrolyte and thus, increase stability but may also cause a decomposition reaction on the surface of a positive electrode surface and thus, form a stable passivation film, improving cycle-life characteristics of a battery.

In some embodiments, the additive for an electrolyte may be included in an amount of about 0.001 wt % to about 5 wt % based on the total amount of the electrolyte. When the additive is included within the range, a stable passivation film may be formed on the surface of the positive electrode, thus protecting electrolyte from oxidation and the electrode material from deterioration. Within the range, the additive for an electrolyte may be included in an amount of about 0.01 to about 2 wt %.

Hereinafter, a rechargeable lithium battery is described referring to drawings.

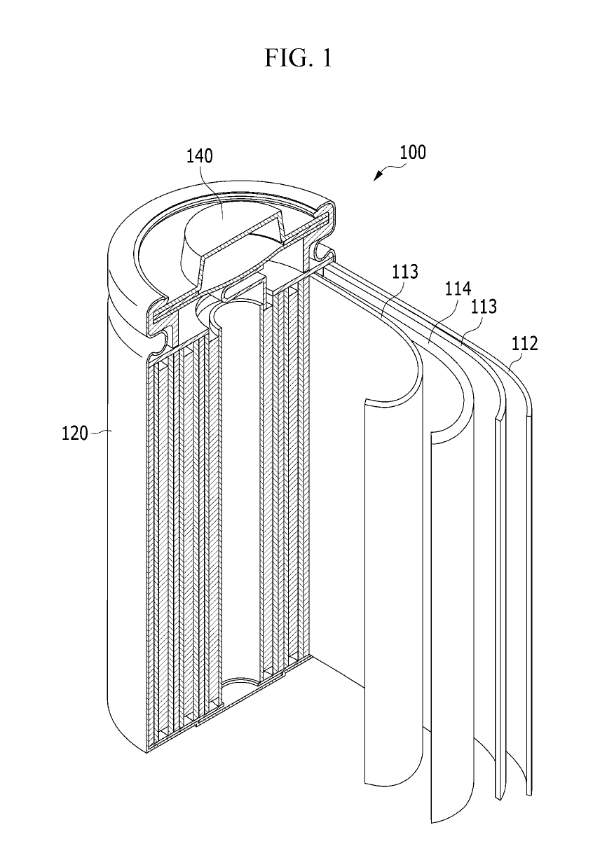

FIG. 1 is a schematic view of a rechargeable lithium battery according to one embodiment.

Referring to FIG. 1, a rechargeable lithium battery 100 according to one embodiment includes a battery cell including a negative electrode 112, a positive electrode 114 disposed facing the negative electrode 112, a separator 113 interdisposed between the negative electrode 112 and positive electrode 114, and an electrolyte (not shown) for a rechargeable lithium battery impregnated in the negative electrode 112, positive electrode 114, and separator 113, a battery case 120 housing the battery cell, and a sealing member 140 sealing the battery case 120.

In some embodiments, the rechargeable lithium battery 100 may be manufactured by sequentially stacking the negative electrode 112, separator 113, and positive electrode 114 and spiral-winding them and housing the wound resultant in the battery case 120.

In some embodiments, the negative electrode 112 includes a current collector and a negative active material layer formed on the current collector.

In some embodiments, the current collector may include a copper foil, a nickel foil, a stainless steel foil, a titanium foil, a nickel foam, a copper foam, a polymer substrate coated with a conductive metal, or a combination thereof.

In some embodiments, the negative active material layer includes a negative active material, a binder and optionally a conductive material.

In some embodiments, the negative active material may include a material that reversibly intercalates/deintercalates lithium ions, a lithium metal, a lithium metal alloy, a material being capable of doping and dedoping lithium, or a transition metal oxide.

In some embodiments, the material that reversibly intercalates/deintercalates lithium ions is a carbon material, and may be any generally-used carbon-based negative active material in a rechargeable lithium ion battery, and examples thereof may be crystalline carbon, amorphous carbon, or a combination thereof. Examples of the crystalline carbon may be a graphite such as a shapeless, sheet-shaped, flake, spherical shaped or fiber-shaped natural graphite or artificial graphite, and examples of the amorphous carbon may be soft carbon or hard carbon, a mesophase pitch carbonized product, fired cokes, and the like.

In some embodiments, the lithium metal alloy may include an alloy of lithium and a metal of Na, K, Rb, Cs, Fr, Be, Mg, Ca, Sr, Si, Sb, Pb, In, Zn, Ba, Ra, Ge, Al, or Sn.

In some embodiments, the material being capable of doping and dedoping lithium may be Si, SiOₓ (0<x<2), a Si—C composite, a Si-Q alloy (wherein Q is an alkali metal, an alkaline-earth metal, Group 13 to 16 elements, a transition metal, a rare earth element, or a combination thereof, and not Si), Sn, SnO₂, a Sn—C composite, Sn—R⁸ (wherein R⁸ is an alkali metal, an alkaline-earth metal, Group 13 to 16 elements, a transition metal, a rare earth element, or a combination thereof, and not Sn), and the like. Specific examples of the Q and R⁸ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. In some embodiments, specific elements of Q and R⁸ may be magnesium (Mg), calcium (Ca), strontium (Sr), barium (Ba), radium (Ra), scandium (Sc), yttrium (Y), titanium (Ti), zirconium (Zr), chromium (Cr), molybdenum (Mo), tungsten (W), iron (Fe), lead (Pb), ruthenium (Ru), osmium (Os), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), or tellurium (Te).

In some embodiments, the transition metal oxide may be vanadium oxide, lithium vanadium oxide, and the like.

In some embodiments, the binder improves binding properties of negative active material particles with one another and with a current collector. Examples thereof may be polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of an electrode. Any electrically conductive material may be used as a conductive material, unless it causes a chemical change. Examples thereof may be a carbon-based material such as natural graphite, artificial graphite, carbon black, acetylene black, ketjen black, carbon fiber and the like; a metal-based material such as a metal powder or a metal fiber and the like of copper, nickel, aluminum, silver, and the like; a conductive polymer such as a polyphenylene derivative and the like; or a mixture thereof.

In some embodiments, the positive electrode 114 includes a current collector and a positive active material layer formed on the current collector.

In some embodiments, the current collector may be Al, but is not limited thereto.

In some embodiments, the positive active material layer includes a positive active material, a binder, and optionally a conductive material.

The positive active material may include lithiated intercalation compounds that reversibly intercalate and deintercalate lithium ions. Specifically, at least one metal composite oxide of lithium and a metal of cobalt, manganese, nickel, or a combination thereof may be used, and specific examples thereof may be a compound represented by one of the following chemical formulae.

LiₐA_{1-b}R_{b}D¹₂ (0.90≦a≦1.8 and 0≦b≦0.5); LiₐE_{1-b}R_{b}O_{2-c}D¹_{c} (0.90≦a≦1.8, 0≦b≦0.5 and 0≦c≦0.05); LiE_{2-b}R_{b}O_{4-c}D¹_{c} (0≦b≦0.5, 0≦c≦0.05); LiₐNi_{1-b-c}Co_{b}R_{c}D¹_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2×α}Z₂ (0.90≦a≦1.8, 0≦b≦0.5, 0≦c≦0.05 and 0<α<2); LiₐNi_{1-b-c}Mn_{b}R_{c}D¹_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A may be Ni, Co, Mn, or a combination thereof; R may be Al, Ni, Co, Mn, Cr, Fe, Mg, Sr, V, a rare earth element, or a combination thereof; D¹ may be O (oxygen), F (fluorine), S (sulfur), P (phosphorus), or a combination thereof; E may be Co, Mn, or a combination thereof; Z may be F (fluorine), S (sulfur), P (phosphorus), or a combination thereof; G may be Al, Cr, Mn, Fe, Mg, La, Ce, Sr, V, or a combination thereof; Q may be Ti, Mo, Mn, or a combination thereof; T may be Cr, V, Fe, Sc, Y, or a combination thereof; and J may be V, Cr, Mn, Co, Ni, Cu, or a combination thereof.

In some embodiments, the positive active material may include the positive active material with the coating layer, or a compound of the active material and the active material coated with the coating layer. In some embodiments, the coating layer may include a coating element compound of an oxide of a coating element, hydroxide of a coating element, oxyhydroxide of a coating element, oxycarbonate of a coating element, or hydroxycarbonate of a coating element. In some embodiments, the compound for the coating layer may be either amorphous or crystalline. In some embodiments, the coating element included in the coating layer may be Mg, Al, Co, K, Na, Ca, Si, Ti, V, Sn, Ge, Ga, B, As, Zr, or a mixture thereof. The coating process may include any conventional processes as long as it does not causes any side effects on the properties of the positive active material (e.g., spray coating, dipping), which is well known to persons having ordinary skill in this art, so a detailed description thereof is omitted.

The binder improves binding properties of positive active material particles with one another and with a current collector. Examples thereof may be polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of an electrode. Any electrically conductive material may be used as a conductive material, unless it causes a chemical change. Examples thereof may be natural graphite, artificial graphite, carbon black, acetylene black, ketjen black, carbon fiber, copper, nickel, aluminum, silver, and the like, a metal powder, a metal fiber, and the like, and one or more kinds of a conductive material such as a polyphenylene derivative and the like may be mixed.

In some embodiments, the negative electrode and the positive electrode may be manufactured by mixing an active material, a binder, and optionally a conductive material in a solvent to prepare an active material composition, and coating the active material composition on each current collector. The solvent includes N-methyl pyrrolidone and the like, but is not limited thereto. The electrode manufacturing method is well known, and thus is not described in detail in the present specification.

In some embodiments, the separator 113 may include anything commonly used in a lithium battery as long as separating a negative electrode 112 from a positive electrode 114 and providing a transporting passage of lithium ion. For example, the separator may have a low resistance to ion transport and an excellent impregnation for electrolyte. In some embodiments, the separator may be selected from a glass fiber, polyester, polyethylene, polypropylene, polytetrafluoroethylene (PTFE), or a combination thereof. In some embodiments, the separator may have a form of a non-woven fabric or a woven fabric. For example, for the lithium ion battery, polyolefin-based polymer separator such as polyethylene, polypropylene or the like is mainly used. In order to ensure the heat resistance or mechanical strength, a coated separator including a ceramic component or a polymer material may be used. Selectively, it may have a mono-layered or multi-layered structure.

Rechargeable lithium batteries may be classified as lithium ion batteries, lithium ion polymer batteries, and lithium polymer batteries according to the presence of a separator and the kind of electrolyte used in the battery. The rechargeable lithium batteries may also be classified as cylindrical, prismatic, coin-type, or pouch-type batteries according to shapes, and may be classified as thin film or bulk batteries. Structures and manufacturing methods for lithium ion batteries pertaining to this disclosure are well known in the art.

The electrolyte is the same as described above.

Hereinafter, the above-described aspects of the present disclosure are illustrated in more detail with reference to examples. However, these examples are exemplary, and the present disclosure is not limited thereto.

### EXAMPLES

### Preparation of Electrolyte

### Preparation Example 1

An electrolyte was prepared by adding 1.0M LiPF₆ to a mixture of ethylene carbonate (EC), ethylmethyl carbonate (EMC), and dimethyl carbonate (DMC) in a ratio of 3/4/3 (v/v/v) to prepare a lithium salt solution and then, 0.2 wt % of 3-methoxythiophene (MOT) thereto based on 100 wt % of the lithium salt solution.

### Preparation Example 2

An electrolyte was prepared by adding 1.0M LiPF₆ to a mixture of ethylene carbonate (EC), ethylmethyl carbonate (EMC), and dimethyl carbonate (DMC) in a ratio of 3/4/3 (v/v/v) and then, 0.08 wt % (ca. 0.008 mol/L) of 3-methoxythiophene (MOT) thereto based on 100 wt % of the lithium salt solution.

### Preparation Example 3

An electrolyte was prepared by adding 1.0M LiPF₆ to a mixture of ethylene carbonate (EC), ethylmethyl carbonate (EMC), and dimethyl carbonate (DMC) in a ratio of 3/4/3 (v/v/v) and then, 0.14 wt % of ethyl thiophene-3-acetate (ETA) thereto based on 100 wt % of the lithium salt solution.

### Preparation Example 4

An electrolyte was prepared by adding 1.0M LiPF₆ to a mixture of ethylene carbonate (EC), ethylmethyl carbonate (EMC), and dimethyl carbonate (DMC) in a ratio of 3/4/3 (v/v/v) and then, 0.11 wt % (ca. 0.008 mol/L) of ethyl thiophene-3-acetate (ETA) thereto based on 100 wt % of the lithium salt solution.

### Preparation Example 5

An electrolyte was prepared by adding 1.0M LiPF₆ to a mixture of ethylene carbonate (EC), ethylmethyl carbonate (EMC), and dimethyl carbonate (DMC) in a ratio of 3/4/3 (v/v/v) and then, 0.01 wt % of ethyl thiophene-3-acetate (ETA) thereto based on 100 wt % of the lithium salt solution.

### Comparative Preparation Example 1

An electrolyte was prepared by adding 1.0M LiPF₆ to a mixture of ethylene carbonate (EC), ethylmethyl carbonate (EMC), and dimethyl carbonate (DMC) in a ratio of 3/4/3 (v/v/v) and then, adding 0.06 wt % (ca. 0.008 mol/L) of 3-methylthiophene (MT) thereto based on 100 wt % of the lithium salt solution.

### Comparative Preparation Example 2

An electrolyte was prepared according to the same method as Preparation Example 1 except for including no 3-methoxythiophene (MOT).

### Manufacture of Rechargeable Lithium Battery Cell 1

### Example 1

A half-cell was manufactured by using a positive electrode including LiNi_{0.6}Co_{0.2}Mn_{0.2}O₂, a lithium metal as a counter electrode, and the electrolyte according to Preparation Example 1.

### Example 2

A half-cell was manufactured in the same method as Example 1 except for using the electrolyte according to Preparation Example 2 instead of the electrolyte according to Preparation Example 1.

### Example 3

A half-cell was manufactured in the same method as Example 1 except for using the electrolyte according to Preparation Example 3 instead of the electrolyte according to Preparation Example 1.

### Example 4

A half-cell was manufactured in the same method as Example 1 except for using the electrolyte according to Preparation Example 4 instead of the electrolyte according to Preparation Example 1.

### Example 5

A half-cell was manufactured in the same method as Example 1 except for using the electrolyte according to Preparation Example 5 instead of the electrolyte according to Preparation Example 1.

### Comparative Example 1

A half-cell was manufactured in the same method as Example 1 except for using the electrolyte according to Comparative Preparation Example 1.

### Comparative Example 2

A half-cell was manufactured in the same method as Example 1 except for using the electrolyte according to Comparative Preparation Example 2.

### Evaluation 1: Formation of Passivation Film

The half-cells according to Examples 3 and 4 and Comparative Examples 1 and 2 were once charged and discharged at 0.2 C, and then, formation of a passivation film on the surface of a positive electrode surface was evaluated.

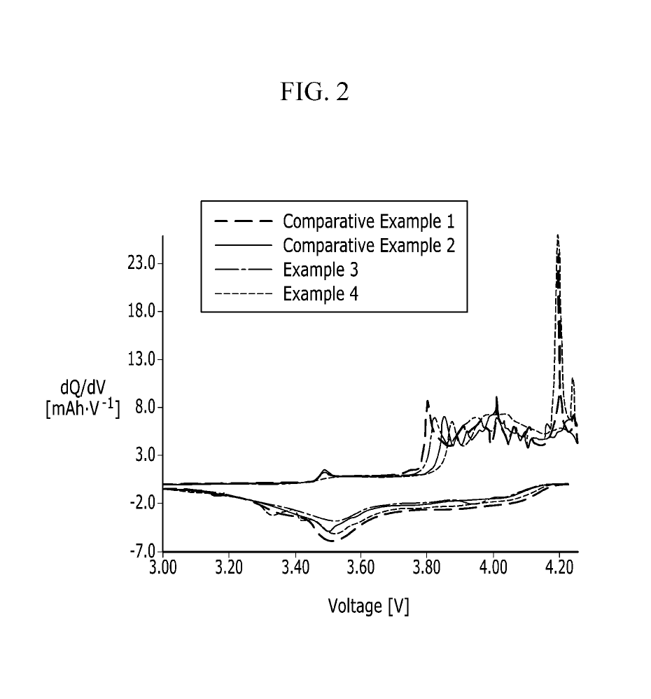

The results are illustrated referring to FIG. 2.

FIG. 2 is a graph showing decomposition potentials of the electrolytes in the half-cells according to Examples 3 and 4 and Comparative Examples 1 and 2.

Referring to FIG. 2, the decomposition potentials of the half-cells according to Examples 3 and 4 started at a lower voltage than those of the half-cells according to Comparative Examples 1 and 2, which shows that passivation films of the half-cells according to Examples 3 and 4 would be easily formed on the surface of a positive electrode.

### Manufacture of Rechargeable Lithium Battery Cell 2

### Example 6

A 2016 coin cell was manufactured by using 92 wt % of LiNi_{0.6}Co_{0.2}Mn_{0.2}O₂, 4 wt % of denka black, and 4 wt % of polyvinylidene fluoride (PVdF, Solef6020), a negative electrode including an alumina-coated graphite negative active material, and the electrolyte according to Preparation Example 1.

### Example 7

A 2016 coin cell was manufactured according to the same method as Example 6 except for using the electrolyte according to Preparation Example 2 instead of the electrolyte according to Preparation Example 1.

### Example 8

A 2016 coin cell was manufactured according to the same method as Example 6 except for using the electrolyte according to Preparation Example 4 instead of the electrolyte according to Preparation Example 1.

### Example 9

A 2016 coin cell was manufactured according to the same method as Example 6 except for using the electrolyte according to Preparation Example 4 instead of the electrolyte according to Preparation Example 1.

### Comparative Example 3

A 2016 coin cell was manufactured according to the same method as Example 6 except for using the electrolyte according to Comparative Preparation Example 1.

### Comparative Example 4

A 2016 coin cell was manufactured according to the same method as Example 6 except for using the electrolyte according to Comparative Preparation Example 2.

### Evaluation 2: Cycle-Life Characteristic

Cycle-life characteristics of the coin cells according to Examples 6 to 8 and Comparative Examples 3 and 4 were evaluated.

The cycle-life characteristics were evaluated by 200 times or 80 times charging and discharging the coin cells according to Examples 6 to 8 and Comparative Examples 3 and 4 at 1C at 25° C. and measuring discharge capacities at each cycle.

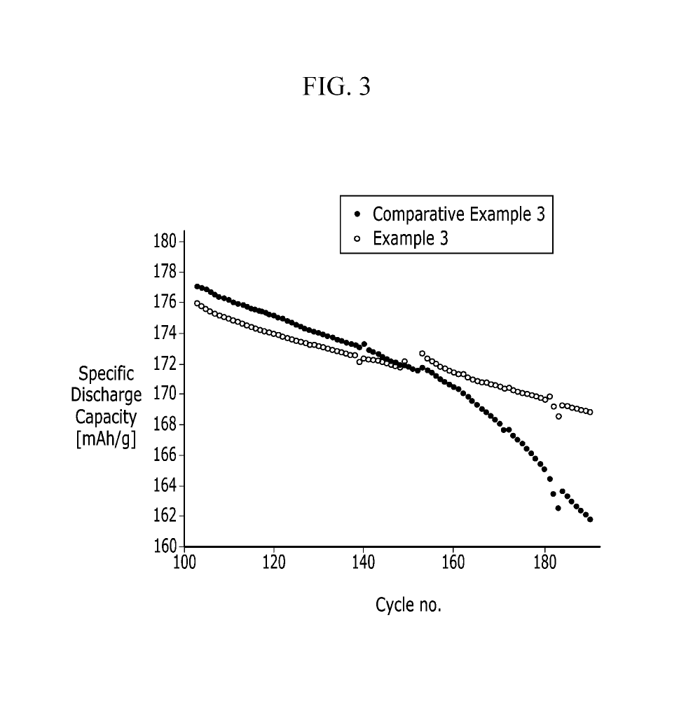

The results are provided in FIGS. 3 to 5.

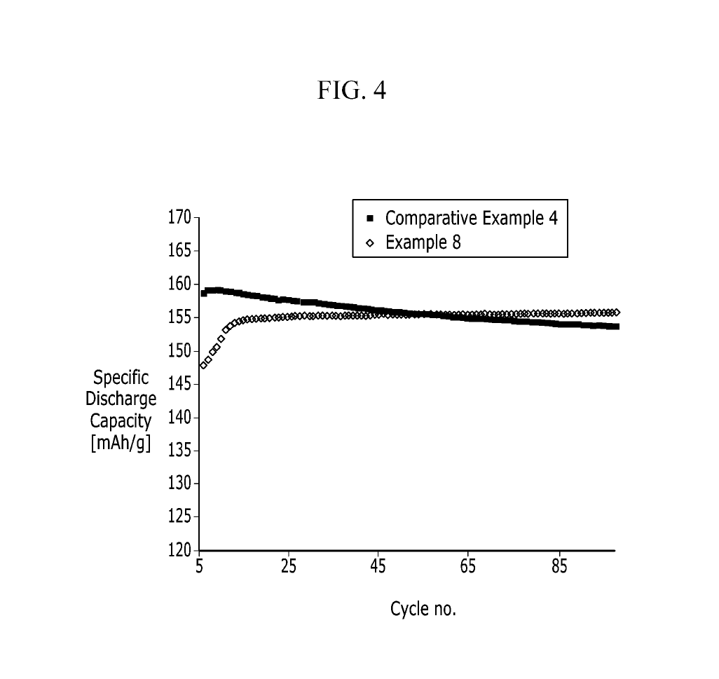

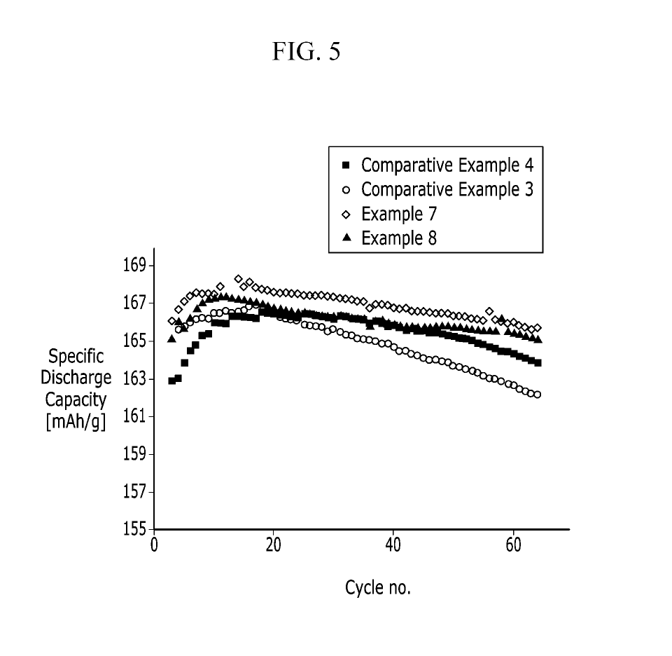

FIG. 3 is a graph showing capacity retentions of the coin cells according to Example 6 and Comparative Example 4 depending on a cycle, FIG. 4 is a graph showing capacity retentions of the coin cells according to Example 8 and Comparative Example 4 depending on a cycle, and FIG. 5 is a graph showing capacity retentions of the coin cells according to Examples 7 and 9 and Comparative Examples 3 and 4 depending on a cycle.

Referring to FIGS. 3 to 5, the coin cells according to Examples 6 to 8 had higher capacity retention depending on a cycle than the coin cells according to Comparative Examples 3 and 4.

### Manufacture of Rechargeable Lithium Battery Cell 3

### Example 9

A three-electrode electrochemical cell was manufactured by using a platinum working electrode (working surface diameter 3 mm), platinum wire as a counter electrode, Li metal as a reference electrode, and the electrolyte according to the Preparation Example 3.

### Comparative Example 5

A three-electrode electrochemical cell was manufactured according to the same method as Example 9 except for using the electrolyte according to Comparative Preparation Example 1.

### Evaluation 3: Electrochemical Stability

Electrochemical stability characteristics of the coin cells according to Example 9 and Comparative Example 5 were evaluated.

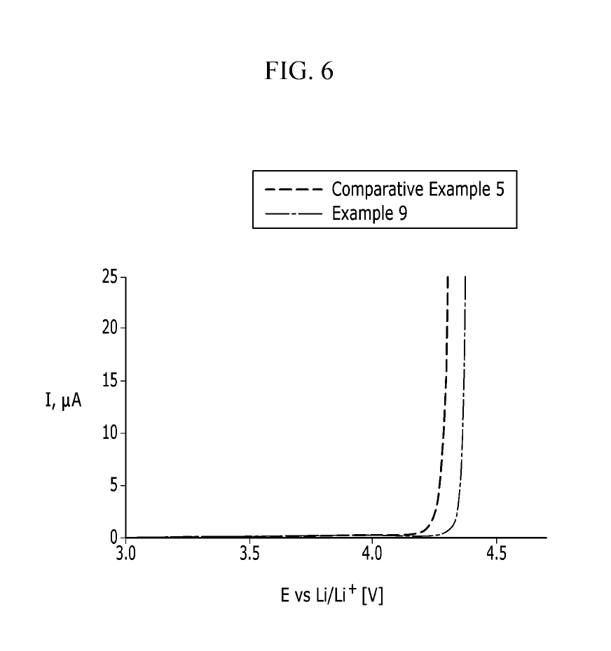

The results are provided in FIG. 6.

FIG. 6 shows a current change depending on a voltage applied to the three-electrode electrochemical cells according to Example 9 and Comparative Example 5, and the cell according to Example 9 had a sharp current change in a region of greater than or equal to 4.4V, and thus, the electrolyte therein had stable electrochemical characteristic in a region of up to 4.4V. On the contrary, the coin cell according to Comparative Example 5 had a sharp current change in a region of 4.2V and deteriorated electrochemical stability in a region of greater than or equal to 4.2V.

In the present disclosure, the terms “Example” and “Comparative Example” are used arbitrarily to simply identify a particular example or experimentation and should not be interpreted as admission of prior art. While this disclosure has been described in connection with what is presently considered to be practical exemplary embodiments, it is to be understood that the invention is not limited to the disclosed embodiments and is intended to cover various modifications and equivalent arrangements included within the spirit and scope of the appended claims.

What is claimed is:

1. An additive for an electrolyte of a rechargeable lithium battery, comprising:
the additive is represented by the following Chemical Formula 1: 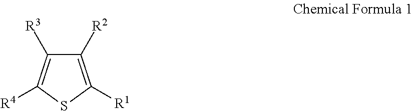
wherein,
R¹ and R⁴ are each independently hydrogen or a C1 to C12 alkyl group;
R² and R³ are each independently —OR′ or —R″C(O)—OR′″;
each R′ is a C1 to C12 alkyl group;
R″ is a C1 to C4 alkylene (alkanediyl) group; and
R′″ is a C1 to C12 alkyl group.

2. The electrolyte of claim 1, wherein Chemical Formula 1 has the structure of Chemical Formula 2 or Chemical Formula 3: 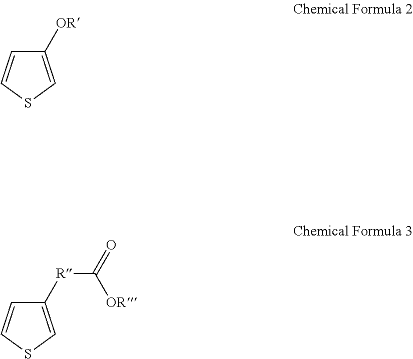
wherein,
R′ and R′″ are independently C1 to C12 alkyl group, and
R″ is a C1 to C4 alkylene (alkanediyl) group.

3. The additive of claim 1, wherein the Chemical Formula 1 has the structure of Chemical Formula 4 or Chemical Formula 5:

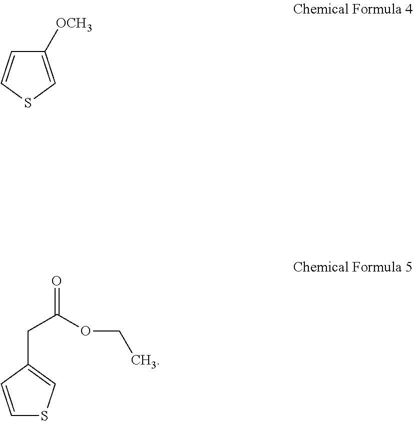 [SMILES: COc1ccsc1 ; CCOC(=O)Cc1ccsc1]

4. An electrolyte for a rechargeable lithium battery, comprising
a lithium salt;
a non-aqueous organic solvent; and
an additive for an electrolyte represented by the following Chemical Formula 1: 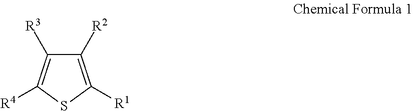
wherein, R¹ and R⁴ are each independently hydrogen or a C1 to C12 alkyl group;
R² and R³ are each independently —OR′ or —R″C(O)-OR′″;
each R′ is a C1 to C12 alkyl group;
R″ is a C1 to C4 alkylene (alkanediyl) group; and
R′″ is a C1 to C12 alkyl group.

5. The electrolyte of claim 4, wherein the Chemical Formula 1 has the structure of Chemical Formula 2 or Chemical Formula 3: 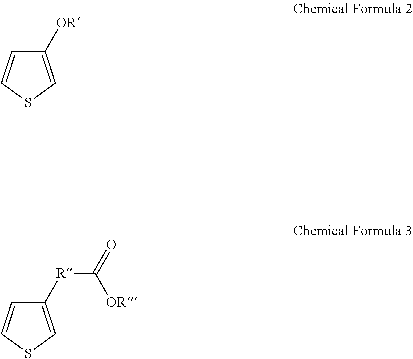
wherein,
R′ and R′″ are independently C1 to C12 alkyl group, and
R″ is a C1 to C4 alkylene (alkanediyl) group.

6. The electrolyte of claim 4, wherein Chemical Formula 1 has the structure of Chemical Formula 4 or Chemical Formula 5:

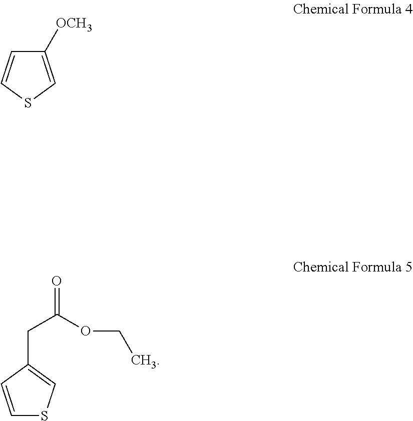 [SMILES: COc1ccsc1 ; CCOC(=O)Cc1ccsc1]

7. The electrolyte of claim 4, wherein the additive for an electrolyte is included in an amount of about 0.001 wt % to about 5 wt % based on the total amount of the electrolyte.

8. The electrolyte of claim 4, wherein the additive for an electrolyte is included in an amount of about 0.01 wt % to about 2 wt % based on the total amount of the electrolyte.

9. A rechargeable lithium battery, comprising
a positive electrode including a positive active material;
a negative electrode including a negative active material; and an electrolyte comprising a lithium salt; a non-aqueous organic solvent; and an additive for an electrolyte represented by the following Chemical Formula 1: 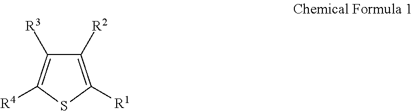
wherein, R¹ and R⁴ are each independently hydrogen or a C1 to C12 alkyl group;
R² and R³ are each independently —OR′ or —R″C(O)—OR′″;
each R′ is a C1 to C12 alkyl group;
R″ is a C1 to C4 alkylene (alkanediyl) group; and
R′″ is a C1 to C12 alkyl group.

10. The rechargeable lithium battery of claim 9, wherein the rechargeable lithium battery further comprises a passivation film positioned on the surface of the positive electrode surface.

11. The electrolyte of claim 4, wherein the Chemical Formula 1 has the structure of Chemical Formula 2 or Chemical Formula 3: 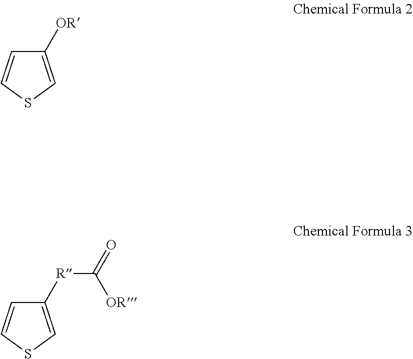
wherein,
R′ and R′″ are independently C1 to C12 alkyl group, and
R″ is a C1 to C4 alkylene (alkanediyl) group.

12. The rechargeable lithium battery of claim 9, wherein Chemical Formula 1 has the structure of Chemical Formula 4 or Chemical Formula 5:

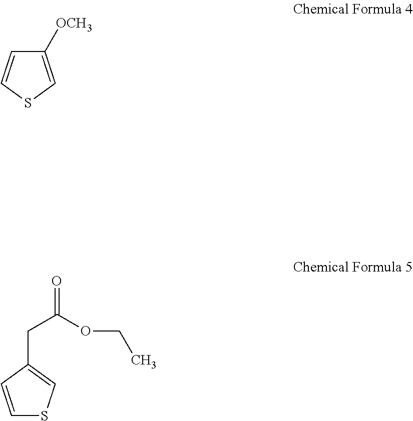

13. The rechargeable lithium battery of claim 9, wherein the additive for an electrolyte is included in an amount of about 0.001 wt % to about 5 wt % based on the total amount of the electrolyte.

14. The rechargeable lithium battery of claim 9, wherein the additive for an electrolyte is included in an amount of about 0.01 wt % to about 2 wt % based on the total amount of the electrolyte.
